(19) United States
(12) Patent Application Publication
(10) Pub. No.: US 2022/0176953 A1
(43) Pub. Date: Jun. 9, 2022

(54) DRIVING ASSISTANCE DEVICE, METHOD FOR ASSISTING DRIVING, AND COMPUTER READABLE STORAGE MEDIUM FOR STORING DRIVING ASSISTANCE PROGRAM

(71) Applicant: J-QuAD DYNAMICS INC., Tokyo (JP)

(72) Inventor: Akira ITO, Tokyo (JP)

(21) Appl. No.: 17/457,755

(22) Filed: Dec. 6, 2021

(30) Foreign Application Priority Data
Dec. 8, 2020 (JP) 2020-203230

(51) Int. Cl. B60W 30/095; B60W 30/09; B60W 40/09; B60W 50/14; B60R 1/00

(52) U.S. Cl. CPC B60W 30/0956; B60W 30/09; B60W 40/09; B60W 2040/0818; B60R 1/00; B60W 2420/42; B60W 50/14

(57) ABSTRACT

A driving assistance device calculates the field of view of a driver based on an output signal of a camera that captures an image of the driver. The driving assistance device calculates a monitoring required region that requires monitoring when driving the vehicle based on information of the periphery of the vehicle. The driving assistance device determines whether the field of view calculated in the field of view calculation process encompasses the monitoring required region. When determined that the calculated field of view does not encompass the monitoring required region, the driving assistance operates predetermined hardware device to cope with the situation.

### 1. FIELD

The following description relates to a driving assistance device, a method for assisting driving, and a computer readable storage medium for storing a driving assistance program.

### 2. DESCRIPTION OF RELATED ART

Japanese Laid-Open Patent publication No. 2009-231937 describes an example of a device that finds a blind spot region formed by an obstacle when approaching an intersection. The device captures images of a moving body before entering the intersection to generate and display an image of the moving body when predicting from the captured images that the moving body will be in the blind spot region.

The device focuses on regions hidden from the driver seat. Thus, as long as the view of a moving body is not blocked, the device will not be effective even if the moving body is outside the field of view of the driver.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a driving assistance device includes circuitry configured to execute a field of view calculation process, a region calculation process, a determination process, and a responding process. In the field of view calculation process, a field of view of a driver is calculated based on an output signal of a camera that captures an image of the driver. In the region calculation process, a monitoring required region that requires monitoring when driving the vehicle is calculated based on information of a periphery of the vehicle. In the determination process, it is determined whether the field of view calculated in the field of view calculation process encompasses the monitoring required region. In the responding process, when determined that the calculated field of view does not encompass the monitoring required region, predetermined hardware is operated to cope with the situation where the calculated field of view does not encompass the monitoring required region.

In the above configuration, the field of view of the driver is calculated based on the output signal of the camera, and it is determined whether the field of view encompasses the monitoring required region. Then, the responding process is executed when it is determined that the calculated field of view does not encompass the monitoring required region to cope with the situation. This improves safety in driving the vehicle, for example, when there is an object obstructing driving of the vehicle in the region outside the field of view of the driver.

Other features and aspects will be apparent from the following detailed description, the drawings, and the claims.

### BRIEF DESCRIPTION OF THE DRAWINGS

FIG. 1 is a diagram showing the configuration of a device in accordance with an embodiment installed in a vehicle.

FIG. 2 is a flowchart illustrating a process executed by an ADAS ECU in accordance with the embodiment.

FIG. 3 is a plan view showing an example of a field of view, a monitoring required region, and a complemented region in accordance with the embodiment.

FIG. 4 is a flowchart illustrating a process executed by the ADAS ECU in accordance with the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment will now be described with reference to the drawings.

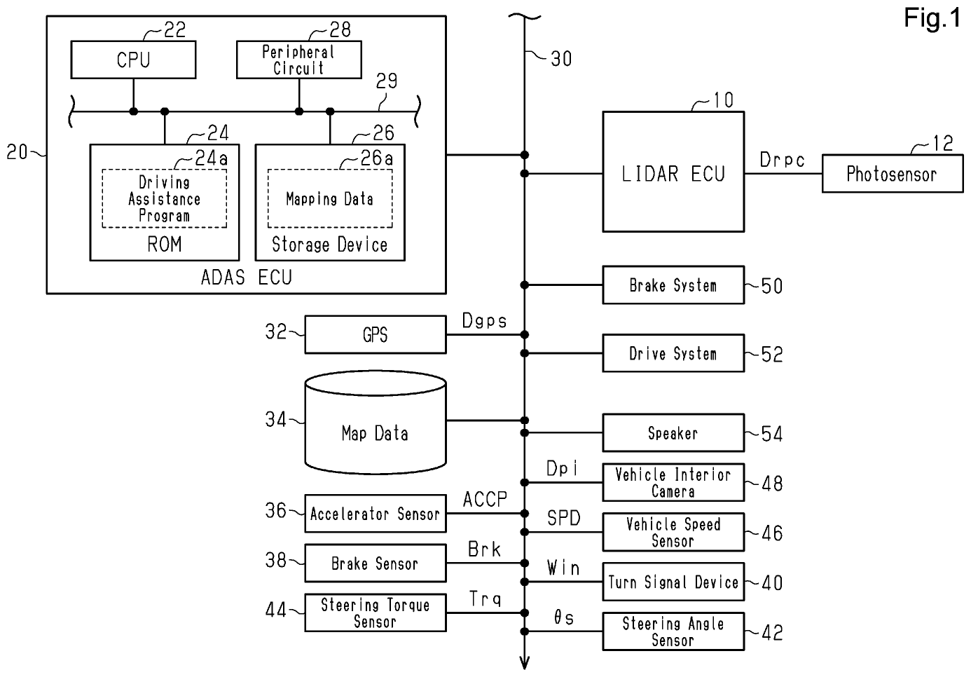

FIG. 1 shows part of a device installed in a vehicle in accordance with the present embodiment.

A photosensor 12 shown in FIG. 1 serves as an object sensor or a distance measurement device and emits, for example, a laser beam of near-infrared light or the like. Also, the photosensor 12 receives reflection light of the laser beam and generates distance measurement point data that indicates a distance variable, a direction variable, and a strength variable. The distance variable indicates the distance between the vehicle and the object reflecting the laser beam. The direction variable indicates the direction in which the laser beam was emitted. The strength variable indicates the reflection strength of the object reflecting the laser beam. The distance measurement point data is obtained by, for example, a time of flight (TOF) method. Alternatively, the distance measurement point data may be generated through, for example, a frequency modulated continuous wave (FMCW) method instead of TOF. In this case, the distance measurement point data may include a speed variable that indicates the relative velocity between the vehicle and the object reflecting the laser beam.

The photosensor 12 emits the laser beam to cyclically scan the horizontal direction and the vertical direction. Then, the photosensor 12 cyclically outputs distance measurement point data group Drpc that is the group of the collected distance measurement point data obtained in a single frame. A single frame corresponds to a single scanning cycle of the horizontal direction and the vertical direction.

A LIDAR electronic control unit (ECU) 10 serves as an object sensor or a distance measurement device and uses the distance measurement point data group Drpc to execute a recognition process on the object that reflected the laser beam. The recognition process may include, for example, a clustering process of the distance measurement point data group Drpc. Further, the recognition process may include a process for extracting a characteristic amount of the measurement point data group that is determined as a single object in the clustering process and inputting the extracted characteristic amount to a discriminative model in order to determine whether the object is a predetermined object. Instead, the recognition process may be a process for recognizing an object by directly inputting the distance measurement point data group Drpc to a deep-learning model.

An advanced driver-assistance (ADAS) ECU 20 executes a process for assisting driving of a vehicle VC. When assisting driving of the vehicle, the ADAS ECU 20 receives the recognition result of the LIDAR ECU 10 via a local network 30. Further, when assisting driving of the vehicle, the ADAS ECU 20 refers to position data Dgps of the global positioning system (GPS 32) and map data 34 via the local network 30.

Also, when assisting driving of the vehicle, the ADAS ECU 20 refers to a state variable that indicates an operation state of an operation member operated by a driver of the vehicle. A state variable will now be described. Specifically, the ADAS ECU 20 refers to accelerator operation amount ACCP and brake operation amount Brk. The accelerator operation amount ACCP is a depression amount of the accelerator pedal detected by an accelerator sensor 36. The brake operation amount Brk is a depression amount of the brake pedal detected by a brake sensor 38. The ADAS ECU 20 further refers to steering angle θs, steering torque Trq, and turn direction signal Win. The steering angle θs is detected by a steering angle sensor 42. The steering torque Trq refers to torque input to the steering wheel and detected by a steering torque sensor 44. The turn direction signal Win indicates the operation state of a turn signal device 40.

Further, as a state variable indicating the state of the vehicle, the ADAS ECU 20 refers to vehicle speed SPD detected by a vehicle speed sensor 46.

When assisting driving of the vehicle, the ADAS ECU 20 further refers to vehicle interior image data Dpi that is image data of the interior of the vehicle VC captured by a vehicle interior camera 48, which is a visible light camera. The vehicle interior camera 48 is a device that mainly captures an image of the driver.

When assisting driving of the vehicle, the ADAS ECU 20 operates a brake system 50, a drive system 52 and a speaker 54.

Specifically, the ADAS ECU 20 includes a central processing unit (CPU) 22, a read-only memory (ROM) 24, a storage device 26, and a peripheral circuit 28. A local network 29 allows for communication between these components. The peripheral circuit 28 includes a circuit that generates clock signals used for internal actions, a power source circuit, a reset circuit, and the like. The storage device 26 is an electrically rewritable non-volatile memory.

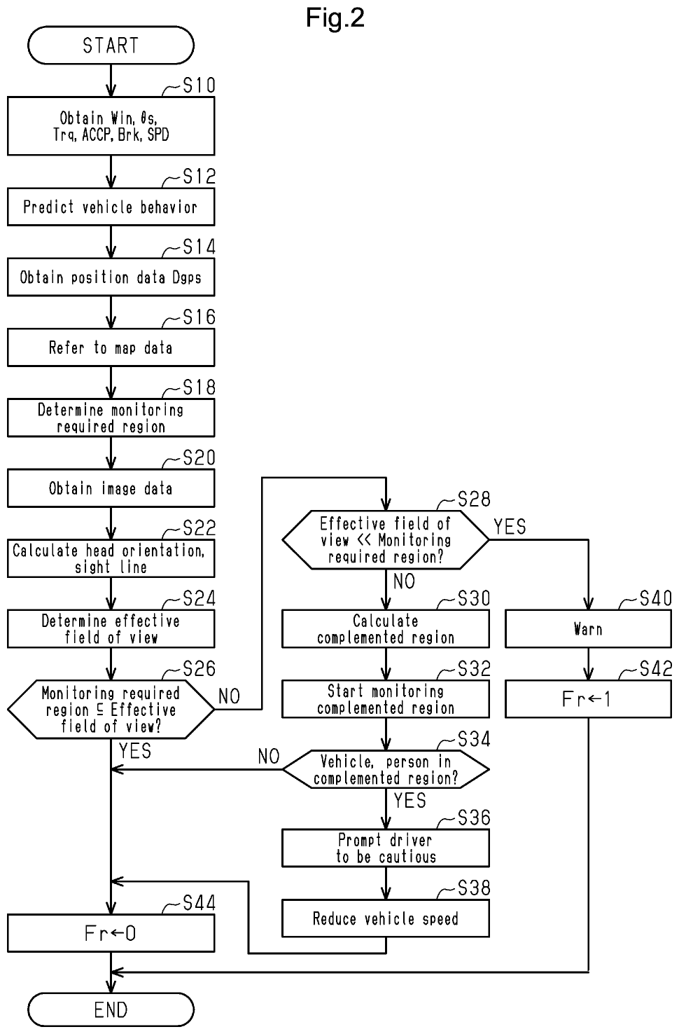

FIG. 2 illustrates a process for assisting driving of the vehicle in accordance with the present embodiment. The process shown in FIG. 2 is implemented, for example, when the CPU 22 repeatedly executes a driving assistance program 24a stored in the ROM 24 in predetermined cycles. In the following description, the letter “S” preceding a numeral indicates a step number of a process.

In the process shown in FIG. 2, the CPU 22 first obtains the turn direction signal Win, the steering angle θs, the steering torque Trq, the accelerator operation amount ACCP, the brake operation amount Brk, and the vehicle speed SPD (S10). Then, the CPU 22 predicts the behavior of the vehicle based on the value of each state variable obtained in S10 (S12). Specifically, for example, when the turn direction signal Win indicates a right turn, the CPU 22 predicts that the vehicle will turn right. The steering angle θs and the steering torque Trq take unique values when the vehicle turns rightward. Nonetheless, the turn direction signal Win indicating the right turn will normally be generated before the vehicle actually turns right. Accordingly, reference to the turn direction signal Win allows the CPU 22 to predict a right turn before predicting the right turn from the steering angle θs and the steering torque Trq. Thus, the process of step S12 includes a process for predicting a turn before the steering angle θs and the steering torque Trq change.

Next, the CPU 22 obtains the position data Dgps (S14). The CPU 22 then refers to the portion of the map data 34 corresponding to the position data Dgps (S16). This process corresponds to an acquisition process for obtaining information related to the road traffic environment around the vehicle.

The CPU 22 calculates, or determines, a monitoring required region that requires monitoring when driving the vehicle based on the behavior of the vehicle predicted in step S12 and the information related to the road traffic environment referred in step S16 (S18). The monitoring required region encompasses a region through which the vehicle is about to travel predicted from the behavior of the vehicle. Further, based on the information related to the road traffic environment, the CPU 22 includes the region in the periphery of the region through which the vehicle is about to travel in the monitoring required region. Specifically, for example, when the vehicle is traveling along a road next to a sidewalk and makes a right turn at an intersection, the CPU 22 includes the nearby sidewalk in the monitoring required region to monitor the sidewalk for pedestrians and check that a pedestrian will not enter the traveling route of the vehicle from the sidewalk when the vehicle is turning right. However, the CPU 22 may not include a nearby sidewalk in the monitoring required region when, for example, there is a pedestrian bridge at an intersection. Steps S12 to S18 correspond to a region calculation process in the present embodiment.

When calculating the monitoring required region, it is preferred that the CPU 22 refer to the vehicle speed SPD. This allows the monitoring required region to be enlarged as the vehicle speed SPD increases.

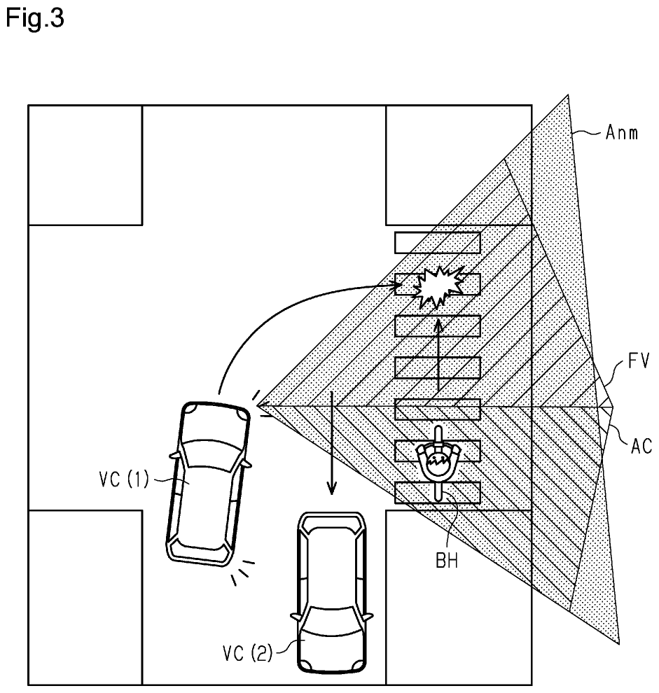

FIG. 3 shows an example of monitoring required region Anm. In FIG. 3, the vehicle VC(1) is turning right at an intersection. Thus, the monitoring required region Anm is set to a region around a crosswalk through which the vehicle is going to pass.

As shown in FIG. 2, the CPU 22 obtains the vehicle interior image data Dpi captured by the vehicle interior camera 48 (S20). Then, the CPU 22 calculates the head orientation and the line of sight of the driver from the vehicle interior image data Dpi (S22). In the present embodiment, a model-based method is employed and the line of sight is estimated by fitting facial and eye models to an input image. Specifically, the storage device 26 shown in FIG. 1 stores mapping data 26a that specifies a map used for outputting a facial characteristic amount based on an input of the vehicle interior image data Dpi. The CPU 22 inputs the vehicle interior image data Dpi to the map to calculate a facial characteristic amount. A facial characteristic amount corresponds to coordinate elements of predetermined characteristic points on a face in an image. Characteristic points on a face include the position of the eyes and other points useful for calculating the head orientation. The map is a convolutional neural network (CNN).

The CPU 22 estimates the head orientation from the coordinates of each characteristic point, which is the facial characteristic amount, using a three-dimensional face model to determine the head position and the face direction. Further, the CPU 22 estimates the center of an eyeball from the head orientation and the coordinates of predetermined facial characteristic points. Then, the CPU 22 estimates the center position of the iris from on the center of the eyeball and an eyeball model. The CPU 22 calculates, or determines, a direction that extends from the center of the eyeball through the center of the iris as a direction in which the line of sight extends.

Subsequently, the CPU 22 calculates, or determines, a predetermined range as an effective field of view from the line of sight (S24). Specifically, the predetermined range is an angular range extending over a predetermined angle or less from each side and centered on the line of sight. The predetermined angle is, for example, 15° to 25°. Steps S20 to S24 correspond to a field of view calculation process in the present embodiment.

FIG. 3 shows an example of effective field of view FV.

As shown in FIG. 2, the CPU 22 determines whether the effective field of view calculated in step S24 encompasses the monitoring required region calculated in step S18 (S26). Step S26 corresponds to a determination process in the present embodiment. When the CPU 22 determines that the calculated effective field of view does not encompass the monitoring required region (S26: NO), the CPU 22 determines whether an overlapping region of the monitoring required region and the effective field of view is smaller than a predetermined proportion of the monitoring required region (S28). The predetermined proportion is set to a value that allows for determination of a state in which the driver is not paying enough attention to driving, such as when the driver is looking away from the road.

When the CPU 22 determines that the overlapping region of the monitoring required region and the effective field of view is greater than or equal to the predetermined proportion (S28: NO), the CPU 22 calculates a region in the monitoring required region that is not overlapping the effective field of view as a complemented region (S30). Specifically, the CPU 22 determines that the driver is paying attention to driving though not enough to ensure safety. Thus, the CPU 22 sets the region that needs be included in the effective field of view FV as the complemented region. Step S30 corresponds to a setting process in the present embodiment.

FIG. 3 shows an example of complemented region AC.

As shown in FIG. 2, the CPU 22 starts a process to monitor for an object in the complemented region that would obstruct driving of the vehicle (S32). Specifically, the CPU 22 instructs the LIDAR ECU 10 to execute an object recognition process on the complemented region. Accordingly, the LIDAR ECU 10 operates the photosensor 12 to emit a laser beam to the complemented region. The LIDAR ECU 10 then executes an object recognition process based on the reflection light of the laser beam, which was emitted to the complemented region, and outputs the result of the recognition process to the ADAS ECU 20. The CPU 22 monitors the result of the recognition process received from the LIDAR ECU 10 to determine whether there is an object in the complemented region that would obstruct driving of the vehicle.

When the CPU 22 determines that there is a vehicle or a person in the complemented region (S34: YES), the CPU 22 operates the speaker 54 to inform the driver of the obstacle and prompt the driver to be cautious (S36). Further, the CPU 22 operates the drive system 52 or operates the drive system 52 and the brake system 50 to reduce the speed of the vehicle (S38). Specifically, when the CPU 22 determines that the vehicle speed can be sufficiently reduced just by decreasing the output of the drive system 52, the CPU 22 operates the drive system 52 to decrease the vehicle speed. Steps S36 and S38 correspond to a responding process in the present embodiment. Further, step S38 corresponds to an operation process of the responding process. When the CPU 22 determines that the vehicle speed cannot be sufficiently reduced by decreasing the output of the drive system 52, the CPU 22 also operates the brake system 50 to apply braking force while decreasing the output of the drive system 52.

When the CPU 22 determines that the overlapping region of the monitoring required region and the effective field of view is smaller than the predetermined proportion of the monitoring required region (S28: YES), the CPU 22 operates the speaker 54, which serves as a notification device, to warn the driver to concentrate on driving (S40). Then, the CPU 22 sets flag Fr to “1” (S42). When the flag Fr is “1”, this indicates that the ADAS ECU 20 is executing a process for intervening driving of the vehicle to avoid a dangerous situation. When the flag is “0”, this indicates that the ADAS ECU 20 is not executing the process for intervening driving. Step S40 also corresponds to the responding process in the present embodiment.

The CPU 22 sets the flag Fr to “0” (S44) when an affirmative determination is given in S26. The CPU 22 also sets the flag Fr to “0” when a negative determination is given in S34. The CPU 22 also sets the flag Fr to “0” when the process of step S38 is completed.

The CPU 22 temporarily ends the process shown in FIG. 2 when the process of step S42 is completed. The CPU also temporarily ends the process shown in FIG. 2 when the process of step S44 is completed.

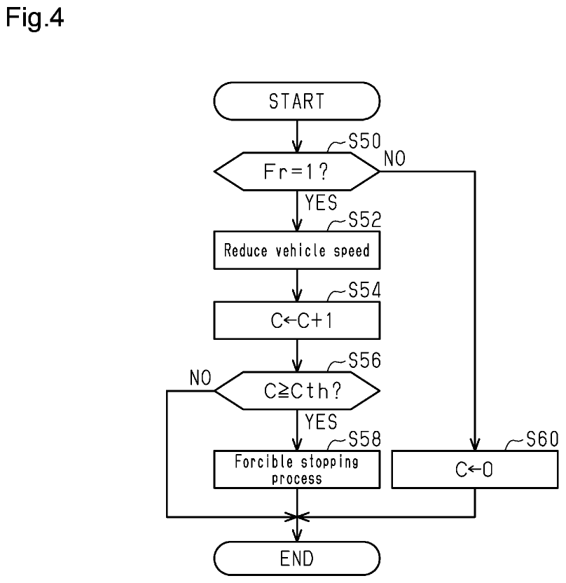

FIG. 4 illustrates a process executed by the ADAS ECU 20 for intervening driving of the vehicle to avoid dangerous situations. The process shown in FIG. 4 is implemented, for example, when the CPU 22 repeatedly executes the driving assistance program 24a stored in the ROM 24 in predetermined cycles.

In the process shown in FIG. 4, the CPU 22 determines whether the flag Fr is “1” (S50). When the CPU 22 determines that the flag Fr is “1” (S50: YES), the CPU 22 decreases the vehicle speed by operating the drive system 52 or by operating the drive system 52 and the brake system 50 (S52). Then, the CPU 22 increments a counter C to measure the time during which the overlapping region of the monitoring required region and the effective field of view is smaller than the predetermined proportion of the monitoring required region (S54). The CPU 22 determines whether the value of the counter C is greater than or equal to a threshold value Cth (S56). The threshold value Cth is set to correspond to a length of time allowing for determination of whether to stop the vehicle when a state continues in which the overlapping region of the monitoring required region and the effective field of view is smaller than the predetermined proportion of the monitoring required region.

When the CPU 22 determines that the counter C is greater than or equal to the threshold value Cth (S56: YES), the CPU 22 forcibly stops the vehicle by operating the drive system 52 and the brake system 50 (S58). Steps S52 and S58 also correspond to the responding process in the present embodiment.

When the CPU 22 determines that the flag Fr is “0” (S50: NO), the CPU 22 initializes the counter C (S60).

The CPU 22 temporarily ends the process shown in FIG. 4 when the process of step S58 is completed. The CPU 22 also temporarily ends the process shown in FIG. 4 when the process of step S60 is completed. The CPU 22 also temporarily ends the process shown in FIG. 4 when a negative determination is given in step S56.

The operation and advantages of the present embodiment will now be described.

The CPU 22 calculates the monitoring required region in accordance with the predicted behavior of the vehicle. Also, the CPU 22 calculates the effective field of view based on the vehicle interior image data Dpi. Then, the CPU 22 determines whether the overlapping region of the effective field of view and the monitoring required region is greater than or equal to the predetermined proportion of the monitoring required region. For example, as shown in FIG. 3, the monitoring required region may not be sufficiently covered by the effective field of view when the driver is looking at the opposing lane while making a right turn. In the example of FIG. 3, the driver is inattentive because the vehicle VC(2) in the opposing lane has moved out of the planned traveling route of the vehicle VC(1). In this case, a person BH on a bicycle is crossing the crosswalk. However, the person BH is outside the effective field of view FV and not noticed by the driver. In this case, the CPU 22 monitoring the complemented region AC detects the person BH and, for example, prompts the driver to be cautious or decreases the vehicle speed. In this manner, the CPU 22 provides assistance when the monitoring required region is not being sufficiently covered by the driver.

In this manner, the driver and the on-board device monitor the monitoring required region together to improve safety.

Further, since the driver and the on-board device cooperate to monitor the monitoring required region together, the photosensor 12 and the LIDAR ECU 10 may be designed to have a smaller laser beam emission region than when there is no such cooperation. This allows the photosensor 12 and the LIDAR ECU 10 to have lower performance. Also, when the laser beam is emitted only to the complemented region AC, the time length of a single frame can be shorter than when the laser beam is emitted to the entire monitoring required region Anm. Furthermore, when the laser beam is emitted only to the complemented region AC, the laser beam can be emitted at a higher density than when the laser beam is emitted to the entire monitoring required region Anm.

The present embodiment, described above, further has the following operation and advantages.

(1) The CPU 22 predicts the behavior of the vehicle based on a variable that indicates the state of the vehicle, such as the vehicle speed SPD, and a variable that indicates an operation amount operated by the driver to drive the vehicle, such as the turn direction signal Win. Then, the CPU 22 calculates the monitoring required region Anm in accordance with the behavior of the vehicle and the information related to the road traffic environment. In this manner, the region that requires monitoring when driving the vehicle is appropriately set.

(2) When a vehicle or a person is detected in the complemented region AC, the CPU 22 reduces the speed of the vehicle. This avoids interference of the traveling vehicle with another moving vehicle or person.

(3) When a vehicle or a person is detected in the complemented region AC, the CPU 22 prompts the driver to be cautious. This induces the driver to monitor the monitoring required region Anm more carefully. In addition, when the CPU 22 executes the process of step S38, the CPU 22 may also notify the driver of the reason the vehicle speed is being reduced against the intention of the driver.

(4) The CPU 22 issues a warning when the overlapping region of the effective field of view FV and the monitoring required region Anm is smaller than the predetermined proportion of the monitoring required region Anm. This prompts the driver to monitor the monitoring required region Anm more carefully.

(5) The CPU 22 reduces the vehicle speed when the overlapping region of the effective field of view FV and the monitoring required region Anm is smaller than the predetermined proportion of the monitoring required region Anm. This avoids a dangerous situation caused by insufficient monitoring of the monitoring required region Anm.

(6) When there are no improvements in the situation even after the CPU 22 issues a warning indicating that the overlapping region of the effective field of view FV and the monitoring required region Anm is smaller than the predetermined proportion of the monitoring required region Anm, the CPU 22 forcibly stops the vehicle. Thus, the vehicle will not continuously travel under an inappropriate situation.

### OTHER EMBODIMENTS

The present embodiment may be modified as follows. The above-described embodiment and the following modifications can be combined as long as the combined modifications remain technically consistent with each other.

Behavior Prediction Process

In the above embodiment, the vehicle speed SPD is used as an example of the variable that serves as an input indicating the state of the vehicle for predicting the behavior of the vehicle. However, there is no limitation to such a configuration. For example, the variable may include at least one of a detection value of acceleration in the front-rear direction, a detection value of acceleration in a sideward direction, and a detection value of yaw rate.

In the above embodiment, the turn direction signal Win, the steering angle θs, the steering torque Trq, the accelerator operation amount ACCP, and the brake operation amount Brk are used as examples of the variable that indicates an operation amount performed by the driver to drive the vehicle. However, there is no limitation to such a configuration. For example, the variable may include an illumination state of the headlamp.

It is not essential that every one of the turn direction signal Win, the steering angle θs, the steering torque Trq, the accelerator operation amount ACCP, and the brake operation amount Brk be included in the variable indicating an operation amount performed by the driver to driver the vehicle.

In the above embodiment, the behavior of the vehicle is predicted based on a variable indicating an operation amount operated by the driver to drive the vehicle and a variable indicating the state of the vehicle. However, there is no limitation to such a configuration. For example, when a destination is set in a navigation system and a traveling route is being guided by the navigation system, the traveling route may be used to predict the behavior of the vehicle.

In the above embodiment, the behavior of the vehicle is predicted when the driver is driving the vehicle. However, there is no limitation to such a configuration. For example, the behavior of the vehicle may be predicted during a period in which the driving mode is being switched between autonomous driving and manual driving. In this case, the behavior of the vehicle may be predicted based on a target traveling path of the vehicle generated when autonomous driving is performed and the above-described variables serving as inputs for predicting the behavior of the vehicle when the driver is driving the vehicle.

It is not essential that the process for predicting the behavior of the vehicle be executed when the driver is driving the vehicle. For example, the process may be executed when autonomous driving is being performed in a manner allowing for shifting to manual driving at any time. In this case, the behavior of the vehicle may be predicted based on the target traveling path of the vehicle generated by autonomous driving.

When predicting the behavior of the vehicle, the CPU 22 may refer to the position data Dgps and the map data 34. In this case, for example, when the brake pedal is depressed near the center of an intersection, a right turn can be predicted more accurately compared to when the position data Dgps and the map data 34 are not referred.

Field of View Calculation Process

The pre-learned model that outputs a facial characteristic amount based on an input of the image data is not limited to a CNN. For example, a decision tree, support-vector regression, or the like may be used.

In the above embodiment, a facial characteristic amount is calculated from a pre-learned model based on an input of image data and then the head orientation, the eyeball position, and the iris position are sequentially obtained from the facial characteristic amount so as to obtain the line of sight. However, there is no limitation to such a configuration. For example, a pre-learned model may output the orientation of the head and the position of the eyeballs based on an input of image data. Alternatively, a pre-learned model may output the position of the iris and the position of the eyeballs based on an input of image data.

In the above embodiment, the line of sight is estimated using a model of the sightline direction extending from the center of the eyeball through the center of the iris. However, a different model may be used in the model-based method. For example, an eyeball model including the form of an eyelid may be used.

The sightline direction may be obtained through a method other than the model-based method. For example, the sightline direction may be obtained through an appearance-based method, with which a pre-learned model outputs a point of regard based on an input of image data. The pre-learned model may be, for example, a linear regression model, Gaussian process regression model, CNN, or the like.

When an infrared light camera is used as described below under “Camera”, the line of sight may be estimated based on the center position of the pupil and a reflection point of the near-infrared light on the cornea, which is determined from the reflection light.

In the above embodiment, the field of view is a region extending over a predetermined angular range and centered on the line of sight. However, this may be changed. For example, the field of view may be a region where an angle formed between the line of sight and the horizontal direction is less than or equal to a first angle and an angle formed between the line of sight and the vertical direction is less than or equal to a second angle. In this case, the first angle may be greater than the second angle. Further, for example, the predetermined angle range may be set to a predetermined fixed value and the field of view may vary in accordance with the vehicle speed.

In the above embodiment, the field of view is assumed as the effective field of view. However, this may be changed. For example, a region including both of the effective field of view and the peripheral field of view may be defined as the field of view that is used for determining the overlapping proportion of the monitoring required region.

Distance Measurement Signal

In the above embodiment, near-infrared light is used in an example of a distance measurement signal emitted to the complemented region. However, the electromagnetic wave signal may be changed. For example, the distance measurement device may be a millimeter wave radar and the distance measurement signal may be a millimeter wave signal. Further, an electromagnetic wave signal does not have to be used and, for example, the distance measurement device may be a sonar and the distance measurement signal may be an ultrasonic wave signal.

Object Sensor

The object sensor does not have to be a device that detects an object with a reflection wave of an output distance measurement signal. For example, the object sensor may be a visible light camera that obtains image data using reflection light of visible light that is not emitted from the vehicle. Even in this case, the visible light camera can be designed to have a lower specification when an object is captured only in the complemented region than when an object is captured in the entire monitoring region.

Responding Process

In the above embodiment, processes of steps S36 and S38 are executed if an object obstructing driving of the vehicle is detected when monitoring the complemented region. However, there is no limitation to such a configuration. For example, only one of steps S36 and S38 may be executed.

It is not essential that the responding process include a notification process that is exemplified in the process of step S36 and an operation process that is exemplified in the process of step S38. For example, only the process of step S40 may be executed when the overlapping portion of the field of view and the monitoring required region is smaller than the predetermined proportion of the monitoring required region. In this case, step S42 and the process of FIG. 4 may be executed.

Determination Process

In the above embodiment, it is determined whether the field of view encompasses the monitoring required region, whether the predetermined proportion of the monitoring required region overlaps the field of view, and whether the proportion of the monitoring required region overlapping the field of view is less than the predetermined proportion. However, there is no limitation to such a configuration. For example, when only the process of step S40 is executed as the responding process, as described under “Responding Process”, it may be determined only in the determination process whether the proportion of the monitoring required region overlapping the field of view is less than predetermined proportion.

Camera

The camera is not limited to a visible light camera and may be an infrared light camera. In this case, an infrared light-emitting diode (LED) or the like may emit near-infrared light onto the cornea of the driver and the camera may receive the reflection light.

Driving Assistance Device

The driving assistance device is not limited to a device that includes a CPU and a program storage device and executes software processing. For example, the driving assistance device may include a dedicated hardware circuit such as an application specific integrated circuit (ASIC) that executes at least part of the software processing executed in the above embodiment. That is, the driving assistance device may be modified as long as it has any one of the following configurations (a) to (c). (a) A configuration including a program storage device and a processor that executes all of the above-described processes according to a program. (b) A configuration including a program storage device, a processor that executes part of the above-described processes according to a program, and a dedicated hardware circuit that executes the remaining processes. (c) A configuration including a dedicated hardware circuit that executes all of the above-described processes. There may be more than one software execution device including a processor and a program storage device and more than one dedicated hardware circuit.

Computer

The computer used for travel assistance of the vehicle is not limited to the CPU 22 shown in FIG. 1. For example, a portable terminal of a user may execute steps S22 and S24 of the process shown in FIG. 2, and the CPU 22 may execute the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A driving assistance device, comprising:
circuitry configured to execute:
a field of view calculation process for calculating a field of view of a driver based on an output signal of a camera that captures an image of the driver;
a region calculation process for calculating a monitoring required region that requires monitoring when driving the vehicle based on information of a periphery of the vehicle;
a determination process for determining whether the field of view calculated in the field of view calculation process encompasses the monitoring required region; and
a responding process for operating predetermined hardware when determined that the calculated field of view does not encompass the monitoring required region to cope with a situation where the calculated field of view does not encompass the monitoring required region.

2. The driving assistance device according to claim 1, wherein
the vehicle includes an object sensor that receives a signal from an object in a detection subject region and detects the object in the detection subject region, and
the responding process includes
a setting process for setting a region that is in the monitoring required region and outside the field of view as a complemented region when determined that the calculated field of view does not encompass the monitoring required region, the complemented region being a monitoring region including the object detected by the object sensor, and
a process for monitoring the complemented region by setting the complemented region to the detection subject region of the object sensor.

3. The driving assistance device according to claim 2, wherein
the object sensor is a distance measurement device that outputs a distance measurement signal to the detection subject region and receives a reflection wave, and
the process for monitoring the complemented region outputs the distance measurement signal toward the complemented region from the distance measurement device to monitor the complemented region.

4. The driving assistance device according to claim 2, wherein the responding process includes a notification process for operating a notification device when the object sensor detects an object obstructing driving of the vehicle to notify the driver of the object.

5. The driving assistance device according to claim 2, wherein the responding process includes an operation process for operating a device that changes velocity of the vehicle when the object sensor detects an object obstructing driving of the vehicle to avoid collision of the vehicle with the object.

6. The driving assistance device according to claim 2, wherein
the setting process is executed when a proportion of the monitoring required region included in the field of view is greater than or equal to a predetermined proportion, and
the responding process includes a process for operating a device that prompts the driver to pay attention to the monitoring required region when the proportion of the monitoring required region included in the field of view is less than the predetermined proportion.

7. The driving assistance device according to claim 1, wherein the responding process includes a process for operating a device that prompts the driver to pay attention to the monitoring required region when determined that the calculated field of view does not encompass the monitoring required region.

8. The driving assistance device according to claim 1, wherein the region calculation process includes:
a behavior prediction process for predicting behavior of the vehicle based on a value of an operation variable that indicates an operation of the vehicle performed by the driver;
an acquisition process for referring to map data based on position information of the vehicle and obtaining information on a periphery of the vehicle; and
a process for calculating the monitoring required region in accordance with the predicted behavior and the information on the periphery of the vehicle.

9. A method for assisting driving, comprising:
calculating a field of view of a driver based on an output signal of a camera that captures an image of the driver;
calculating a monitoring required region that requires monitoring when driving the vehicle based on information of a periphery of the vehicle;
determining whether the field of view calculated in the field of view calculation process encompasses the monitoring required region; and
operating predetermined hardware when determined that the calculated field of view does not encompass the monitoring required region to cope with a situation where the calculated field of view does not encompass the monitoring required region.

10. A computer readable storage medium storing a driving assistance program that has a computer execute the field of view calculation process, the region calculation process, the determination process, and the responding process in the driving assistance device according to claim 1.
